(19) United States
(12) Patent Application Publication
(10) Pub. No.: US 2020/0342400 A1
(43) Pub. Date: Oct. 29, 2020

(54) SHIPPING MANAGEMENT DEVICE AND METHOD

(71) Applicants: HONGFUJIN PRECISION ELECTRONICES (YANTAI) CO.,LTD., Yantai (CN); HON HAI PRECISION INDUSTRY CO., LTD., New Taipei (TW)

(72) Inventors: LIAN-JIE WEI, Yantai (CN); FU-QIANG HE, Shenzhen (CN); KUNG-CHIEH CHENG, New Taipei (TW); NAN-NAN SONG, Yantai (CN)

(21) Appl. No.: 16/419,654

(22) Filed: May 22, 2019

(30) Foreign Application Priority Data
Apr. 26, 2019 (CN) 201910345996.2

(51) Int. Cl. G06Q 10/08; G06Q 10/10; G06F 17/24; H04L 29/08

(52) U.S. Cl. CPC G06Q 10/0838; H04L 67/142; G06F 17/248; G06Q 10/10

(57) ABSTRACT

A shipping management device includes a processor and a memory. The processor obtains shipment application information, generates an electronic application form based on the shipment application information, reviews the electronic application form, determines whether the electronic application form meets requirements, generates an electronic release order according to the electronic application form when the electronic application form meets the requirements, sends the electronic release order to a verification terminal, receives verification information from the verification terminal, updates the electronic release order after receiving the sending information, updates shipment information as sending completion or sending abnormality, updates the electronic release order after receiving receipt information, and updates the shipment information as receipt completion or receipt abnormality.

### FIELD

The subject matter herein generally relates to shipping, and more particularly to a shipping management device and method.

### BACKGROUND

Existing shipping management systems involve large amounts of paperwork, which is easily mismanaged and difficult to trace.

### BRIEF DESCRIPTION OF THE DRAWINGS

Implementations of the present disclosure will now be described, by way of embodiments, with reference to the attached figures.

FIG. 1 is a block diagram of an embodiment of a shipping management device.

FIG. 2 is a block diagram of functional modules of a shipping management system.

FIG. 3 is a flowchart of a shipping management method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

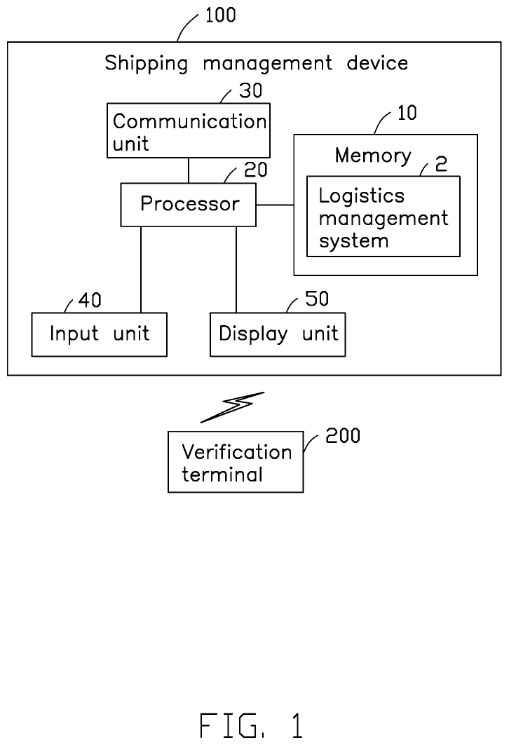

FIG. 1 shows a block diagram of an embodiment of a shipping management device 100 for managing logistics of shipments.

The shipment management device 100 includes, but is not limited to, a memory 10, a processor 20, a communication unit 30, an input unit 40, and a display unit 50. The memory 10 stores a shipping management system 2. The memory 10, the communication unit 30, the input unit 40, and the display unit 50 are electrically coupled to the processor 20. In one embodiment, the shipment management device 100 can be a computer, a server, a controller, or the like.

The shipping management device 100 establishes a communication connection with a verification terminal 200 through a network, such as a wireless or wired network.

The memory 10 can be, but is not limited to, a Read-Only Memory (ROM), a Random Access Memory (RAM), a Programmable Read-Only Memory (PROM), an Erasable Programmable Read-Only Memory (EPROM), a One-Time Programmable Read-Only Memory (OTPROM), an Electronically-Erasable Programmable Rewritable Read-Only Memory (EEPROM), a Compact Disc Read-Only Memory (CD-ROM), or other optical disc storage, disk storage, tape storage, or any other computer readable medium by which data can be carried or stored.

The processor 20 may be composed of an integrated circuit, such as a single packaged integrated circuit, or may be composed of multiple integrated circuits of the same function or different functions, including one or more central processing units, microprocessors, digital processing chips, graphics processors, or a combination of various control chips.

The communication unit 30 establishes a communication connection with the verification terminal 200. The communication unit 30 can be a wired communication unit or a wireless communication unit. In one embodiment, the communication unit 30 establishes a communication connection with the verification terminal 200 through a wireless network, which may be, but is not limited to, WIFI, Bluetooth, a mobile cellular network, a satellite network, or the like.

It can be understood that, in other embodiments, the communication unit 30 further establishes a communication connection with a communication server, a text message server, and a mail server. The communication unit 30 establishes a communication connection with the communication server, the text message server, and the mail server through a wired network.

The input unit 40 inputs various information and control commands by one or more of a mouse, a keyboard, a touch screen, a voice input device, or the like.

The display unit 50 displays related data results processed by the processor 20. The display unit 50 may be, but is not limited to, a touch display screen or a liquid crystal display screen.

The verification terminal 200 verifies shipment information at a sending location and at a receiving location and reports verification information of the shipment information. In one embodiment, the verification terminal 200 is a terminal having OCR (Optical Character Recognition) character recognition functions to scan a work card of an employee to obtain work card information, inquire shipment information from the shipping management device 100 according to the work card information, verify the shipment at the sending location and at the receiving location based on the shipment information, and transmit the verification information of the shipment information to the shipping management device 100.

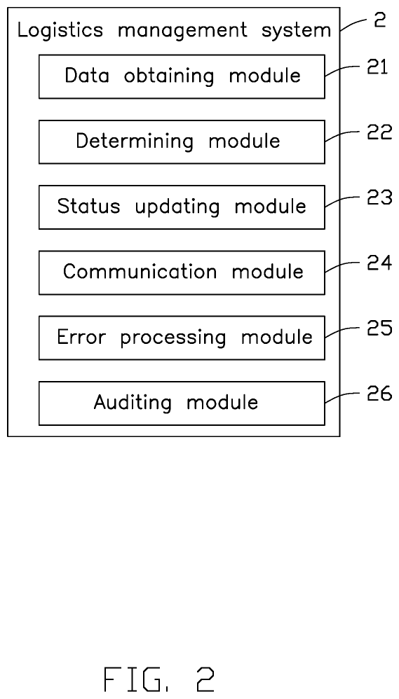

In one embodiment, the shipment management system 2 may include computer instructions in the form of one or more programs stored in the memory 10 and executed by the processor 20. In one embodiment, the shipping management system 2 can be integrated into the processor 20. In other embodiments, the shipping management system 2 may also be independent of the processor 20. Referring to FIG. 2, the shipping management system 2 may include one or more modules, such as a data obtaining module 21, a determining module 22, a status updating module 23, a communication module 24, an error processing module 25, and an auditing module 26.

The data obtaining module 21 obtains shipment application information, and generates an electronic application form based on the shipment application information. Specifically, the shipment application information includes a sending location, a receiving location, a sender name, a sender work number, a courier name, a courier work number, a recipient name, recipient contact information, a shipment name, a shipment quantity, a packaging method, a courier method, and remarks. The electronic application form information includes the sending location, the receiving location, the sender name, the sender work number, the courier name, the courier work number, the recipient name, the recipient contact information, the shipment name, the shipment quantity, the packaging method, the courier method, the remarks, and a signoff log. The signoff log is a compilation of electronic signatures during a course of shipping, including a signature of personnel in charge at the sending location, confirmation personnel at the sending location, personnel in charge at the receiving location, confirmation personnel at the receiving location, and the like.

The determining module 22 determines whether a shipping status of the shipment is normal according to sending information and receipt information. The determining module 22 further determines whether the receipt information is received within a preset time after the sending information is updated as complete.

The status updating module 23 updates an electronic release order in real time and displays the electronic release order in real time on the display unit 50. The status updating module 23 obtains verification information from the communication module 24, obtains signing information from the auditing module 26, and updates the electronic release order according to the verification information and the signing information. For example, after the shipment has been sent, the shipping status is updated as sent completion or sent abnormality, and after the shipment has been received, the shipping status is updated as receipt completion or receipt abnormality, and according to the signing information, the shipping status is updated as shipment completion or shipment abnormality. The shipping status is updated as complete or abnormal according to the signing information. The electronic release order includes an electronic release order number, a shipping direction, a recipient name, a packaging method, a release form generation date, an applicant name, a courier name and work number, an audit status, receipt information, sending information, shipping status information, and anomaly descriptions.

The communication module 24 sends the electronic release order to the verification terminal 200, and receives verification information from the verification terminal 200. The verification information includes receipt information and sending information. The communication module 24 sends the shipping status information to the communication server, the text message server, or the mail server to send the shipping status information to the applicant, the personnel in charge at the sending location, or the personnel in charge at the receiving location by mail, text message, or phone message. The shipping status information includes information of sent completion, receipt completion, sent abnormality, receipt abnormality, shipment completion, and shipment abnormality. The communication module 24 sends alarm information to the communication server, the text message server, or the mail server to send a mail, text message, or phone message to the applicant, the person in charge at the sending location, or the person in charge at the receiving location. The alarm information includes the abnormal electronic release order number, a cause of the abnormality, and the name or work number of the abnormal electronic release order applicant. The reasons for the abnormality include, but are not limited to, excessive time of delivery and an abnormality of receipt of shipment. The excessive time of delivery refers to not receiving receipt information of the receiving location after a predetermined amount of time after the shipment is sent. The abnormality of receipt of shipment refers to the shipment received not matching a description on the electronic release order.

The error processing module 25 processes abnormal situations in the electronic release order. The abnormal situations include excessive time of delivery and abnormality of receipt of shipment. A corresponding processing measure is selected according to the abnormal situation. For example, if the abnormal situation is excessive time of delivery, the corresponding processing measure is to lock the electronic release order and send the alarm information.

The auditing module 26 reviews the electronic application form, determines whether the electronic application form meets requirements, and generates the electronic release order according to the electronic application form when the electronic application form meets the requirements. The auditing module 26 further generates the signing information based on the electronic release order and determines whether completion of the shipment meets requirements according to the signing information. Specifically, the electronic release order includes an electronic release order number, a shipping direction, a recipient name, a packaging method, a release form generation date, an applicant name, a courier name and work number, an audit status, a receipt information, delivery information, shipping status information, and anomaly descriptions. The packaging method includes a cardboard box, for example. The audit status includes initial audit completion, unaudited, initial audit failure, final audit completion, and final audit failure.

The delivery information includes a sending confirmation personnel, a sending time, and an abnormality description. When a courier takes out a shipment from a warehouse, the sending confirmation personnel uses the verification terminal 200 to scan the work card information of the courier to obtain a relevant electronic release order according to the scanned work card information. The shipment is verified according to the electronic release order, and the verification information is reported to the shipping management system 2. If an abnormality exists in the verification, the courier is forbidden from taking out the shipment, and a cause of the abnormality is reported. The receiving information includes a receipt time, a receipt confirmation personnel, and an abnormality description. When a courier arrives at a warehouse, the receipt confirmation personnel uses the verification terminal 200 to scan the work card information of the courier to obtain the relevant electronic release order. The shipment is verified according to the electronic release order, and the verification information is reported to the shipping management system 2. If an abnormality exists in the verification, a cause of the abnormality is reported. The shipping status information includes information of sent completion, receipt completion, sent abnormality, receipt abnormality, shipment completion, and shipment abnormality.

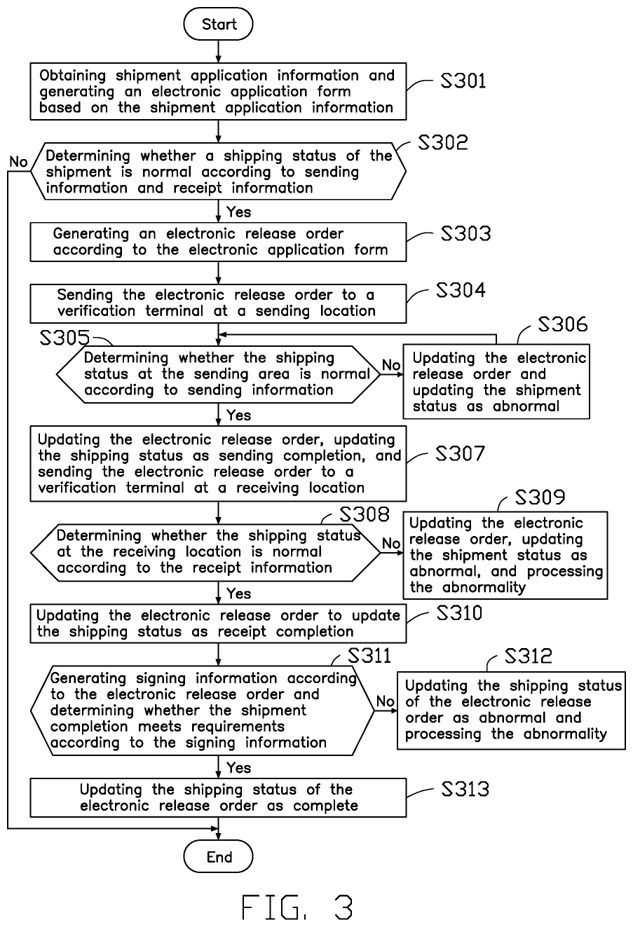

FIG. 3 shows a flowchart of a shipping management method implemented by the shipping management device 100. The method is provided by way of embodiment, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure.

At block S301, shipment application information is obtained, and an electronic application form based on the shipment application information is generated. Specifically, the shipment application information includes a sending location, a receiving location, a sender name, a sender work number, a courier name, a courier work number, a recipient name, recipient contact information, a shipment name, a shipment quantity, a packaging method, a courier method, and remarks. The electronic application form information includes the sending location, the receiving location, the sender name, the sender work number, the courier name, the courier work number, the recipient name, the recipient contact information, the shipment name, the shipment quantity, the packaging method, the courier method, the remarks, and a signoff log. The signoff log is a compilation of electronic signatures during a course of shipping, including a signature of personnel in charge at the sending location, confirmation personnel at the sending location, personnel in charge at the receiving location, confirmation personnel at the receiving location, and the like.

At block S302, whether a shipping status of the shipment is normal according to sending information and receipt information is determined. If the shipping status is abnormal, the method ends. If the shipping status is normal, block S303 is implemented.

At block S303, an electronic release order is generated according to the electronic application form.

Specifically, an electronic release order is generated according to the electronic application form when the electronic application form is determined to meet requirements.

The electronic release order includes an electronic release order number, a shipping direction, a recipient name, a packaging method, a release form generation date, an applicant name, a courier name and work number, an audit status, receipt information, sending information, shipping status information, and anomaly descriptions.

At block S304, the electronic release order is sent to the verification terminal 200 at the sending location, so that the shipment at the sending location can be checked and the delivery information can be acquired from the verification terminal 200.

Specifically, the electronic release order is sent to the verification terminal 200 at the sending location, and delivery information is received from the verification terminal 200 at the sending location. The delivery information includes a sending confirmation personnel, a sending time, and an abnormality description.

In one embodiment, the verification terminal 200 is a terminal having OCR character recognition functions to scan a work card of an employee to obtain work card information, inquire shipment information from the management device 100 according to the work card information, verify the shipment at the sending location and at the receiving location based on the shipment information, and transmit the verification information of the shipment information to the shipping management device 100.

The verification terminal 200 verifies the electronic release sheet, records the shipment information, and transmits the shipment information to the shipment management device 100.

In another embodiment, information of the verification terminal 200 at the sending location is recorded in the electronic release order. After generating the electronic release order, the electronic release order is directly sent to the verification terminal 200 at the sending location and the verification terminal 200 at the receiving location.

At block S305, whether the shipping status at the shipping area is normal is determined according to sending information.

If the shipping status is abnormal, block S306 is implemented. If the shipping status is normal, block S307 is implemented.

At block S306, the electronic release order is updated, the shipment status is updated as abnormal, and then block S305 is implemented.

Specifically, the electronic release order is updated according to the sending information, and the shipment status is updated as abnormal.

At block S307, the electronic release order is updated, the shipping status is updated as sending completion, and the electronic release order is sent to the verification terminal 200 at the receiving location, so that the shipment can be checked according to the electronic release order, and receipt information is received from the verification terminal 200 at the receiving location.

Specifically, the electronic release order is updated according to the sending information, the electronic release order is transmitted to the receiving location verification terminal 200, and the receipt information issued by the receiving location verification terminal 200 is received. The receipt information includes a receipt time, a receipt confirmation personnel, and an anomaly description.

At block S308, whether the shipping status at the receiving location is normal is determined according to the receipt information. If the shipping status is abnormal, block S309 is implemented. If the shipping status is normal, block S310 is implemented.

At block S309, the electronic release order is updated, the shipment status information is updated as abnormal, and the abnormality is processed.

Specifically, the electronic release order is updated according to the receipt information, and the shipping status is updated as abnormal. A corresponding processing measure is selected and executed according to the abnormality reason. The processing measure includes sending an alarm message to a communication server, a text message server, or a mail server.

At block S310, the electronic release order is updated to update the shipping status as receipt completion.

At block S311, signing information is generated according to the electronic release order, and whether the shipment completion meets requirements according to the signing information is determined.

For example, whether a shipment requirement is satisfied or whether a shipment quantity is satisfied is determined. If the shipment requirement is not satisfied, block S312 is implemented. If the shipment requirement is satisfied, block S313 is implemented.

At block S312, the shipping status of the electronic release order is updated as abnormal, and the abnormality is processed.

At block S313, the shipping status of the electronic release order is updated as complete.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A shipping management device comprising:
a processor; and
a memory storing a plurality of instructions, which when executed by the processor, causes the processor to:
obtain shipment application information, and generate an electronic application form based on the shipment application information;
review the electronic application form, determine whether the electronic application form meets requirements, and generate an electronic release order according to the electronic application form when the electronic application form meets the requirements, the electronic release order comprising an electronic release order number and a shipping status, the shipping status comprising information of sent completion, receipt completion, sent abnormality, receipt abnormality, shipment completion, and shipment abnormality;
send the electronic release order to a verification terminal, and receive sending information or receipt information from the verification terminal;
update the electronic release order after receiving the sending information, and update shipment information as sent completion or sent abnormality, and update the electronic release order after receiving the receipt information, and updating the shipment information as receipt completion or receipt abnormality.

2. The shipping management device of claim 1, further comprising a communication unit, an input unit, and a display unit, wherein:
the communication unit establishes a communication connection with the verification terminal;
the input unit inputs shipment application information;
the display unit displays the electronic release order information.

3. The shipping management device of claim 2, wherein the processor is further caused to:
determine whether a shipping status of the shipment is normal according to the sending information and the receipt information;
select and execute a corresponding processing measure when the shipping status is abnormal, the processing measure comprising sending alarm information.

4. The shipping management device of claim 3, wherein the processor is caused to:
determine whether receipt information is received within a predetermined time period after the shipping status is updated as sent completion; and
determine that the shipping status is receipt abnormality when the receipt information is not received within the predetermined time.

5. The shipping management device of claim 2, wherein the processor is further caused to:
determine whether the electronic application form meets requirements, and generate the electronic release order when the electronic application form meets requirements;
generate signing information according to the electronic release order after the shipping status is updated as receipt completion, and determine whether the shipment completion meets requirements according to the signing information.

6. A shipping management method comprising:
obtaining shipping application information, and generating an electronic application form according to the shipping application information, the electronic application form comprising an electronic release order number and a shipping status, the shipping status comprising information of sent completion, receipt completion, sent abnormality, receipt abnormality, shipment completion, and shipment abnormality;
generating an electronic release order according to the electronic application form;
sending the electronic release order to a verification terminal at a sending location for a shipment verification at the sending location according to the electronic release order;
receiving sending information from the verification terminal at the sending location and updating the shipping status as sent completion;
sending the electronic release form to a verification terminal at a receiving location for the shipment verification at the receiving location according to the electronic release order;
receiving verification information from the verification terminal at the receiving location; and
updating the shipping status as receipt completion.

7. The shipping management method of claim 6, further comprising:
determining whether the electronic application form meets requirements; and
generating the electronic release order when the electronic application form meets requirements.

8. The shipping management method of claim 6, further comprising:
determining, after receiving the verification information from the verification terminal at the sending location, whether the shipping status at the sending location is normal according to the sending information;
updating the electronic release order when the shipping status is abnormal, updating the shipping status as sent abnormality, and returning to the step of determining whether the shipping status is normal according to the sending information;
updating the electronic release order when the shipping status is normal, and updating the shipping status as sent completion.

9. The shipping management method of claim 6, further comprising:
determining, after receipt information is received, whether the shipping status at the receiving location is normal according to the receipt information;
updating the electronic release order when the shipping status is abnormal, updating the shipping status as receipt abnormality, and sending alarm information, the alarm information comprising an abnormal electronic release order number and an abnormality reason;
updating the electronic release order when the shipping status is normal, and updating the shipping status as receipt completion.

10. The shipping management method of claim 6, further comprising:
generating signing information after updating the shipping status as receipt completion, and determining whether the shipment satisfies requirements according to the signing information;
updating the electronic release order shipping status as shipment completion when the shipment satisfies requirements; and
updating the electronic release order shipping status as shipment abnormality when the shipment does not satisfy requirements, and sending alarm information, the alarm information comprising an electronic release order number and an abnormality reason.
